(19) United States
(12) Patent Application Publication
(10) Pub. No.: US 2006/0011742 A1
(43) Pub. Date: Jan. 19, 2006

(54) Sprinkler head for efficiently watering curved landscapes

(76) Inventor: Prasada Rao Mallela, Fullerton, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/894,955

(22) Filed: Jul. 19, 2004

(51) Int. Cl. B05B 15/06

(52) U.S. Cl. 239/200

(57) ABSTRACT

A new sprinkler head that can optimally water curved landscapes is presented here in. Existing sprinkler heads although perform well for regular landscapes, are not efficient when used across curved landscapes. The proposed inventive sprinkler has an inbuilt mechanism that can take into account the curvature of the landscape and thus optimally water the curved landscapes. In the preferred embodiments, the sprinkler head has a plurality of radially directed output ports or orifices. Each such output port is associated with a corresponding control channel and a blocking device which may be in the form of a threaded screw. The extent of insertion of the blocking device within each flow channel determines the flow discharge and hence the water throw distance (i.e., radius of water arc) from the corresponding outlet port. The flow in each output port can thus be independently and variably controlled from zero flow to full flow. These two end flow conditions will reflect in the radius of the water arc to correspondingly vary from zero to a maximum, for a constant water pressure in the pipe.

### BACKGROUND OF THE INVENTION

1. Field of the Invention

The present invention relates generally to water sprinkler heads of the type used to water lawns and the like. The invention relates more specifically to a new sprinkler head having multiple orifices each with independent water radius control to optimally water curved landscapes and hence minimize water waste.

2. Background Art

According to the U.S. Geological Survey of the 26 billion gallons of water consumed daily in the United State, approximately 30 percent (i.e., 7.8 billion gallons) is spent on outdoor uses. A significant portion on the water is spent in landscaping. It is estimated that a typical suburban lawn consumes 10,000 gallons of water above and beyond rainwater each year. Existing sprinklers although they perform well in the interior regions of any large landscapes, when used in the vicinity of the borders in a curved landscape, spill water on to its adjacent hardscape (i.e., sidewalk, driveway, roads, et al.) Although there is no known precise estimate of the amount of water that is spilled onto driveways/hardscape, it is safe to say that for curved landscapes a significant amount of water does spill on to the hardscape, thus contributing to water wastage

The motivation of this invention is to design a new sprinkler head that can optimally water curved landscapes. Existing sprinkler heads although perform well for regular landscapes, are far from optimal when used across curved landscapes. Depending on the degree of curvature of the landscape, existing sprinklers spill water onto hardscapes (i.e., sidewalks, driveways, roads, etc.), thus contributing to among others; water wastage and added surface runoff pollution. The inventive sprinkler has an inbuilt mechanism that can take into account the curvature of the landscape and thus optimally water the landscape. It provides a practical approach for efficiently watering curved landscapes. With growing population and dwindling water sources, the advantages of using the inventive sprinkler head are manifold, including water conservation and reduced surface runoff that carries pollutants to oceans and other water bodies. Additionally, an improved sprinkler system can also open new windows for improved landscape design. Since urban lifestyle and good landscaping go hand-in-hand, an offshoot of this work is an enhanced quality of life. The inventive sprinkler can benefit both the end users and water management agencies. The target audiences that can benefit from the inventive sprinkler head are water managers, home owners, city planner/decision makes, landscape designers and architects.

Currently there exist many sprinkler heads (both from spray and rotor sprinklers) which can be used for watering regular and irregular landscapes. While the standard spray sprinkler nozzles (that typically operate around an operating pressure of 30 psi) have many characteristic features, the feature closest to the proposed sprinkler is their ability to water quarter, half and full circle areas, which facilitates directing water to any particular area of interest (i.e., the watering arc can be changed from 45° to 90°, from 90° to 180° et al.). By using the arc adjustment screw, the watering arc can also be altered. Independent of the degree of the arc, the water spray will continue to be uniform all across the flow area(viz., the radius of the water arc is constant). Since the radius of the water arc is constant, while the radius of curved landscape is not constant, the existing sprinklers cannot be optimally used for curved landscapes.

A search of the prior art found the following relevant issued U.S. patents:

| | |
|---|---|
| 3,664,590 | Knight |
| 4,119,275 | Hunter |
| 4,131,234 | Pescetto |
| 4,189,099 | Bruninga |
| 4,625,917 | Torney |
| 4,739,934 | Gewelber |
| 5,050,800 | Lamar |
| 5,226,602 | Cochran et al |
| 6,019,295 | McKenzie |

Lamar '800 discloses a sprinkler nozzle assembly having a cylindrical head with a plurality of spaced spray orifices arranged in a ring around the periphery of the head, each orifice connecting to a common inlet and each having a radial outlet for directing a radial spray. Each orifice has a removable plug and there is an adjustable flow rate device for the entire array of orifices. The various orifices have different arc widths to permit selection of a desired arc of spray by removing one or more plugs. One may also employ different orifice wall dimensions to achieve different spray ranges from different orifices.

McKenzie '295 provides a sprinkler nozzle having an adjustable arc using a variable blocking skirt.

Cochran et al '602 discloses an adjustable radius sprinkler nozzle using an adjustable deflecting member.

Knight '590 discloses a sprinkler head having a controlled pattern using a slotted or apertured disk or mask.

Hunter '275 discloses a sprinkler head having multiple orifices with cross-sectional areas which vary progressively and a common flow restrictor with cam-like shape.

Gewelber '934 shows a sprinkler head having a plurality of plugged radially arrayed orifices. The user punches open the plugs depending upon the pattern desired. Torney '917 is similar, but employs removable slots instead of punchable plugs.

Bruninga '099 discloses a sprinkler head having replaceable cap members each providing a different spray pattern.

### SUMMARY OF THE INVENTION

An optimal sprinkler head for curved/irregular landscape should have a feature in it, by which the radius of flow emanating from each nozzle opening can be independently controlled. Such a mechanism will facilitate the end user to choose the appropriate radius of the water arc for each nozzle opening, so that no water spills onto hardscape. Assuming that this can be done by using a flow adjustment screw, the characteristic feature of this screw should include:
Each nozzle opening should consist of one flow adjustment screw (while a nozzle can have any number of openings).
The flow adjustment screw in a completely closed position, shuts off the flow from that particular nozzle.
The flow adjustment screw in a completely open position implies that the flow from that nozzle opening is at its peak value.
Any intermediate location of the flow adjust screw implies that the discharge rate from that nozzle is between its minimum (i.e., zero) and maximum values.
Since the cross-sectional area of the nozzle opening is constant, varying the flow discharge in any nozzle opening will alter the radius of the water arc emanating from that nozzle opening.

Building upon above theory, I have designed, fabricated and tested a series of sprinkler heads with varying number of nozzle openings. The nozzles had 1, 2, 3, 4 and 6 openings, respectively.

The features in this new sprinkler nozzle/head are:
The radius of the uniform water arc emanating from each nozzle opening can be set independently so that no water sprays onto the walkways/driveways.
The spraying pattern across any nozzle is uniform, and this is independent of the location of the flow adjustment screw
For landscapes with steep curvature, a nozzle with multiple openings can be chosen to water the whole landscape area efficiently. For landscapes across road dividers, a nozzle with a single opening can be chosen to water the landscape efficiently.
For using the sprinkler head, no additional learning/training is required from the end user.
No additional investment is needed from the end user to install the new sprinkler head into their landscape.
It can be used for both pop-up style sprinklers and shrub style sprinklers.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is an upward looking three-dimensional view of a preferred embodiment of a sprinkler head assembly in accordance with the invention;

FIG. 2 is a downward view similar to FIG. 1, but showing the assembly attached to a water supply pipe;

FIG. 3 is a top view of the head of FIG. 1;

FIG. 4 is a side view of the head of FIG. 1;

FIG. 5 is a three-dimensional front view of the head of FIG. 1;

FIG. 6 is a front plan view of the head of FIG. 1;

FIG. 7 is a three-dimensional view of a multiple port version of the head of FIG. 1;

FIG. 8 is a side view showing the control screw ready to be installed in the head;

FIG. 9 is a front view of an alternative embodiment sprinkler head of the invention;

FIG. 10 is a side view of the head of FIG. 9.;

FIG. 11 is a side view of a control screw used in the head of FIG. 9;

FIG. 12 is a front view of the control screw of FIG. 11;

FIG. 13 is a definition sketch to illustrate the performance characteristics (i.e., varying radius of water arc's) of head shown in FIG. 7, with the number of output ports being equal to 2; and

FIG. 14 is a definition sketch to illustrate the performance characteristics (i.e., varying radius of water arc's) of head shown in FIG. 7, with the number of output ports being equal to 3.

### DETAILED DESCRIPTION OF PREFERRED EMBODIMENTS

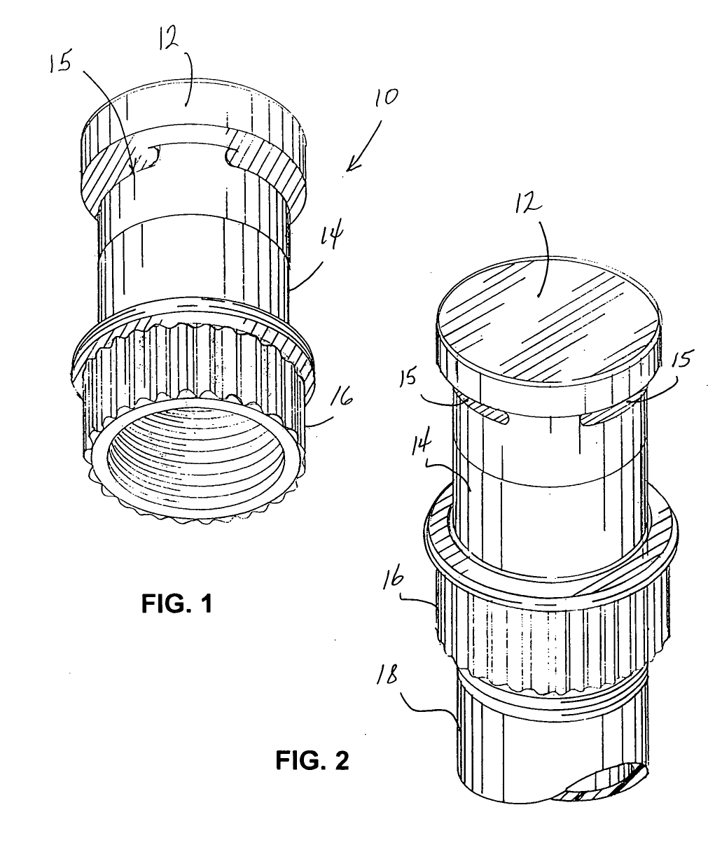

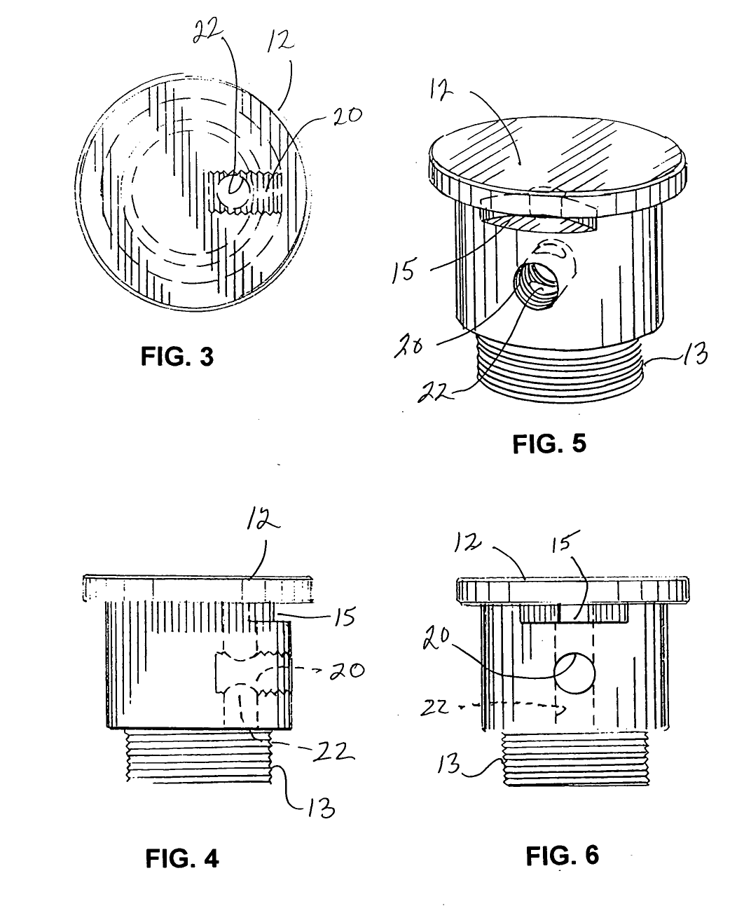

Referring to the accompanying drawings and initially to FIGS. 1-8 in particular, it will be seen that a sprinkler head assembly 10 comprises a sprinkler head 12, a shaft 14 and a threaded base 16 for attachment to a water pipe 18. Head 12 has a plurality of radial-facing output ports 15. Each such port is in communication with a vertical flow channel 22 seen best in FIGS. 3-6. Each flow channel 22 is, in turn, in fluid communication with the water pipe 18 for flow of water up channel 22 and out through port 15.

Control of the amount of flow through each output port 15 is accomplished using a control screw 25 (see FIG. 8) threadably engaged with a horizontal control channel 20. The extent to which screw 25 extends into channel 20 determines the extent to which it blocks flow channel 22 and thus the amount of water flow through channel 22 and output port 15. The amount of blockage may be varied from zero to complete by simply controlling the extent of threading of screw 25 into channel 20. Each output port 15 flow may be independently controlled by means of a separate screw 25 for that port.

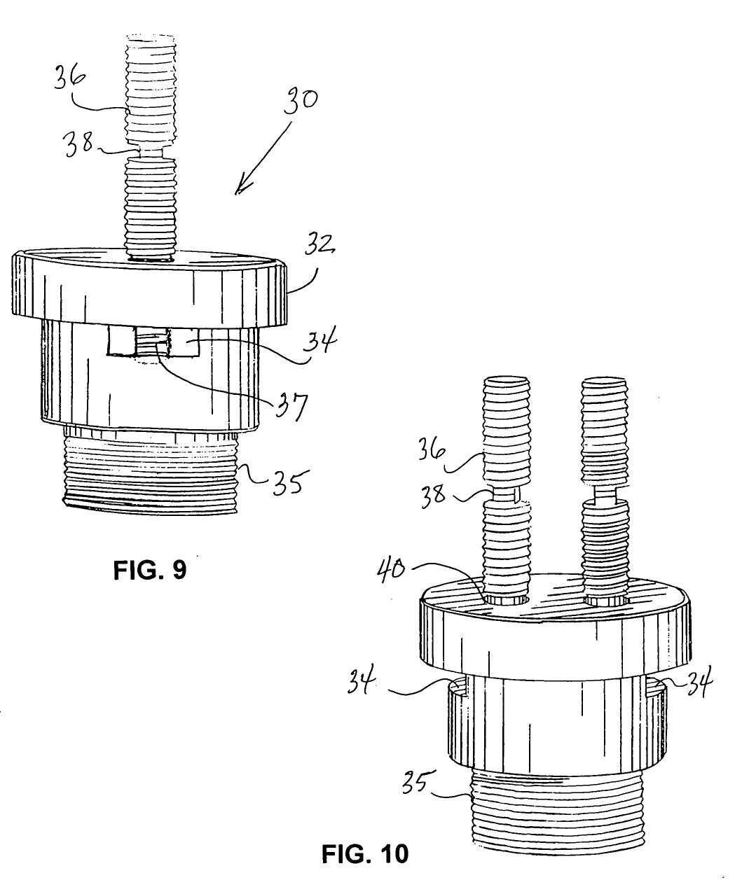

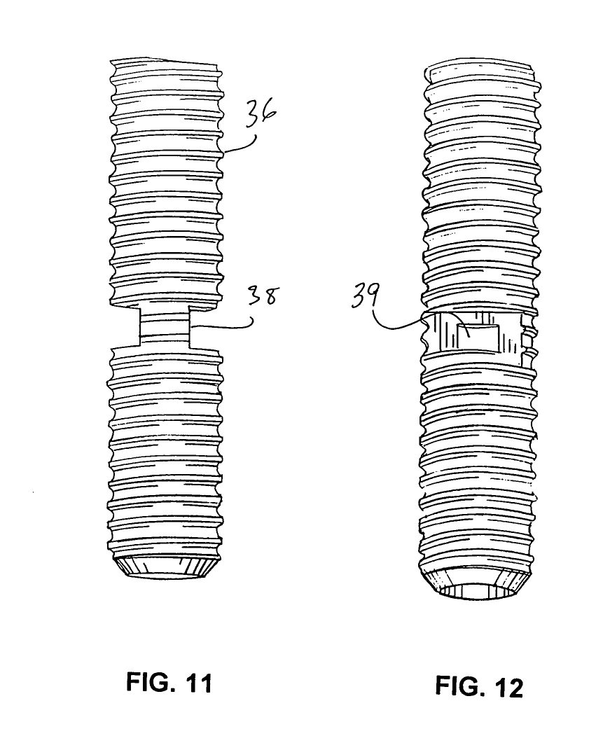

An alternative embodiment sprinkler head assembly 30 is shown in FIGS. 9 and 10. In this embodiment, the head 32 has output ports 34 each having a short horizontal channel 37 which, in turn, is in fluid communication with a vertical flow channel 40. Each channel 40 is threadably configured to receive a threaded control screw 36. As shown best in FIGS. 11 and 12, each such screw 36 has a center recessed area or gap 38 with an orifice 39. When orifice 39 is aligned with output port 15, water flow is un-restricted. When screw 36 is adjusted to mis-align orifice 39 from output 15, the flow becomes restricted and can ultimately be blocked entirely. Each output port has its own control screw which can be independently controlled to control flow from that corresponding port.

The control screw 36 is hollow below gap 38 to enable flow from the channel 40 to the orifice 39 and hence to output port 34.

In each of the embodiments disclosed herein, the number of output ports may be as few as one and as many as at least six, preferably configured symmetrically around the head. Regardless of the number of output ports, the flow from each and thus the range of water reach in that direction, may be independently controlled with a corresponding control screw as described herein.

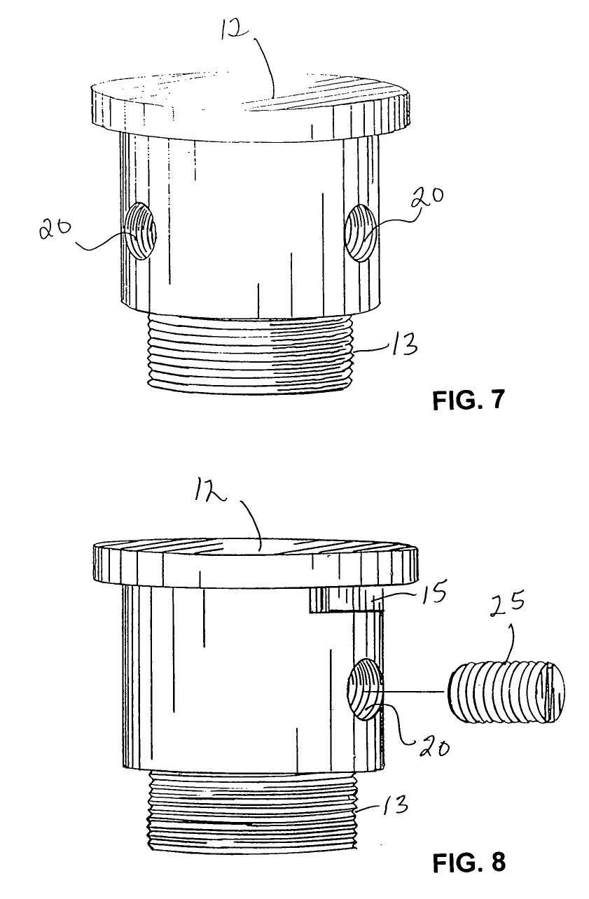

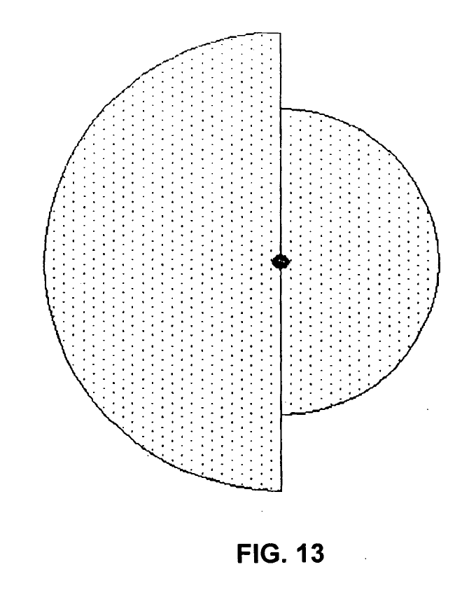

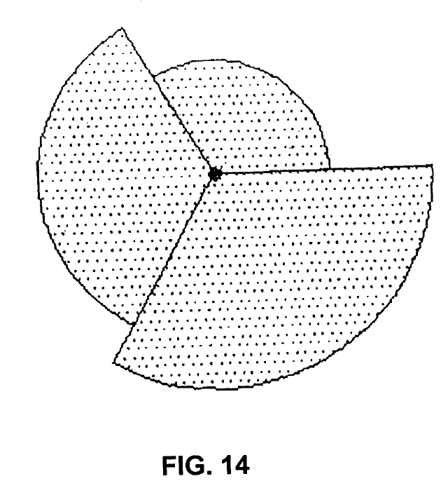

FIG. 13 is a definition sketch to illustrate the performance details of head shown in FIG. 7, with two control screws 25 threaded into the flow channels to different depths. The figure shows that this mechanism enables one to achieve two different water radius arcs. FIG. 14 is a definition sketch to illustrate the performance details of a head with three control screws 25, threaded into the flow channels to different levels.

Having thus disclosed preferred embodiments of the invention, it will be understood that various modifications and additions may be made to the illustrated versions. By way of example, other control channel configurations that employ the inventive features herein, may be readily made with the benefit of the disclosed teaching. Moreover, each head may be readily provided with a greater number of output ports than the number shown herein. Accordingly, the scope hereof is to be limited only by the appended claims and their equivalents.

I claim:

1. A sprinkler head having a base for attachment to a water pipe for directing water radially for watering lawns and the like; the head comprising:
at least one radially directed output port in fluid communication with said base;
at least one threaded channel having at least a portion interposed between said output port and said base; and
at least one control screw threadably engaged with said threaded channel for selectively and variably blocking flow through said output port depending upon the position of said control screw within said threaded channel relative to said interposed portion.

2. The sprinkler head recited in claim 1 wherein said threaded channel is substantially parallel to said output port.

3. The sprinkler head recited in claim 1 wherein said threaded channel is substantially perpendicular to said output port.

4. The sprinkler head recited in claim 1 wherein said control screw is configured to provide a range of flow blocking from 0% to 100%.

5. A sprinkler head having a base for attachment to a water pipe for directing water radially for watering lawns and the like; the head comprising:
a plurality of radially directed output ports in fluid communication with said base;
each said output port having threaded channel having at least a portion interposed between said output port and said base; and
each said threaded channel having a control screw threadably engaged with said threaded channel for selectively and variably blocking flow through the corresponding output port depending upon the position of said control screw within said threaded channel relative to said interposed portion.

6. The sprinkler head recited in claim 5 wherein said threaded channel is substantially parallel to said output port.

7. The sprinkler head recited in claim 5 wherein said threaded channel is substantially perpendicular to said output port.

8. The sprinkler head recited in claim 5 wherein said control screw is configured to provide a range of flow blocking from 0% to 100%.

9. The sprinkler head recited in claim 5 wherein said plurality of output ports are spaced symmetrically around the entire radial surface of said head.

10. The sprinkler head recited in claim 5 wherein each said threaded channel is positioned on the radial surface of said head.

11. The sprinkler head recited in claim 5 wherein each said threaded channel is positioned on the top surface of said head.

12. A sprinkler head having a base for attachment to a water pipe for directing water radially in a number of different directions for watering lawns and the like; the head comprising:
a plurality of radially directed output ports in fluid communication with said base;
each said output port having a control channel having at least a portion interposed between said output port and said base; and
each said control channel having a control device engaged within said control channel for selectively and variably blocking flow through said output port depending upon the position of said control device within said control channel relative to said interposed portion, the distance of watering from each said output port being independently determined by the position of each corresponding control device in a corresponding control channel.
